(19) United States
(12) Patent Application Publication
(10) Pub. No.: US 2006/0015775 A1
(43) Pub. Date: Jan. 19, 2006

(54) System and method for observing the behavior of an integrated circuit (IC)

(76) Inventors: John Benavides, Garland, TX (US); Tyler Johnson, Murphy, TX (US); Richard W. Adkisson, Dallas, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/890,782

(22) Filed: Jul. 14, 2004

(51) Int. Cl. G06F 11/00

(52) U.S. Cl. 714/30

(57) ABSTRACT

A system and method for observing the functional behavior of a target circuit. In one embodiment, a first interface, which is external with respect to the target circuit, is provided for generating behavioral definitions relative to the target circuit. A programmer module is used, responsive to the behavioral definitions, for generating a programmation file that manipulates a logic analyzer, which is embedded with respect to the target circuit. An observability tool is provided for utilizing the programmation file to observe the target circuit's functionality. A second interface, which is external with respect to the target circuit, displays results relative to observing the target circuit's functionality.

### BACKGROUND

Functional verification is a critical process which integrates all phases of the design process, including high-level system design, module implementation, and board-level integration (e.g., Application Specific Integrated Circuit (ASIC) and Printed Circuit Board (PCB) integration), by verifying that the design complies with all system requirements and has been correctly translated from higher to lower levels of abstraction including the behavior of the IC. Due to the increasing complexity of today's ICs and time-to-market pressures, greater importance has been placed on functional verification in the design and development of electronic products utilizing advanced, feature-rich chipsets, e.g., high performance processors, ASICs, et cetera. For instance, particular importance has been placed on the development and implementation of functional verification techniques that accelerate verification and utilize economical instrumentation to provide nonintrusive visibility into internal signal states of the ASIC.

By way of an example, the functional verification of ASICs involves breaking the functional specification into a set of modules, developing a comprehensive test plan and procedures, and then coding test generators and result checkers to exercise the ASIC and validate the adherence to the architectural, performance, and functional specifications. Typically, the testing generators and result checkers are embodied in external instrumentation which interfaces with the ASIC. Despite the capabilities of the existing external instrumentation, further improvements in the functional verification of ASICs, processors, and other types of target circuits are warranted as will described in greater detail below.

### SUMMARY

A system and method are disclosed that provide for observing the functional behavior of a target circuit. In one embodiment, a first interface, which is external with respect to the target circuit, is provided for generating behavioral definitions relative to the target circuit. A programmer module is used, responsive to the behavioral definitions, for generating a programmation file that manipulates a logic analyzer, which is embedded with respect to the target circuit. An observability tool is provided for utilizing the programmation file to observe the target circuit's functionality. A second interface, which is external with respect to the target circuit, displays results relative to observing the target circuit's functionality.

### BRIEF DESCRIPTION OF THE DRAWINGS

FIG. 1 depicts a block diagram of a system level embodiment for observing a target circuit's functionality;

FIG. 2 depicts a block diagram of an embodiment of the embedded logic analyzer programmer presented in FIG. 1;

FIG. 3 depicts a block diagram of a first embodiment of the system for observing the target circuit;

FIG. 4 depicts a block diagram of a second embodiment of the system for observing the target circuit;

FIG. 5 depicts a block diagram of a third embodiment of the system for observing the target circuit;

FIG. 6 depicts a block diagram of a fourth embodiment of the system for observing the target circuit; and

FIG. 7 depicts a flow chart of a method for observing a target circuit's functionality according to one embodiment.

### DETAILED DESCRIPTION OF THE DRAWINGS

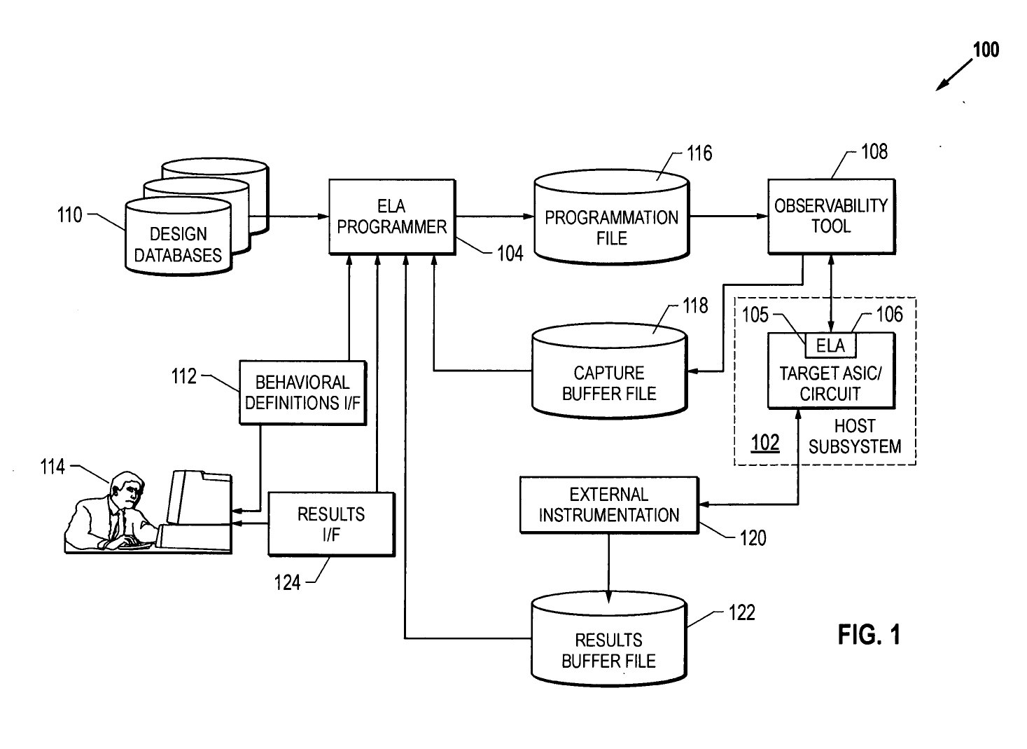

In the drawings, like or similar elements are designated with identical reference numerals throughout the several views thereof, and the various elements depicted are not necessarily drawn to scale. FIG. 1 depicts a system 100 for observing a target circuit's functional behavior according to one embodiment of the present invention. A host subsystem 102 includes a target circuit 106, which may be an ASIC, having an embedded logic analyzer (ELA) 105. Design databases 110 provide logic connectivity and signaling information that describes the target circuit 106. By way of example, in an ASIC design embodiment, the design databases 110 include a list of gates and a netlist that specifies the connectivity of the gates.

In the illustrated embodiment, the system 100 may be implemented as a computer platform wherein the host subsystem 102 including the target circuit 106 is disposed. The embedded logic analyzer 105 of the target circuit 106 is effectuated by hardware that is added to the circuit 106 during the design process. This permits the embedded logic analyzer 105 to be able to access internal signals while not being restricted by the pins of the fabricated circuit. Accordingly, the embedded logic analyzer 105 overcomes the limitation of limited access to internal signals associated with conventional external logic analyzers. As will be seen below, the embedded logic analyzer 105 is manipulated via a suitable observability tool 108 that is interfaced with a programmation file 116 for effectuating acquisition, analysis, and viewing of the observability data related to the functional behavior (or a portion thereof) of the target circuit 106. Specifically, an embedded logic analyzer programmer structure 104 that is interfaced with a behavioral definitions interface 112, which may be considered a first interface, is operable for generating behavioral definitions that specify internal signal state routing circuits, signal state storage, control logic functionality, and external interface control, for example. As illustrated, the behavioral definitions interface 112 is external with respect to the host subsystem 102 and, in particular, the target circuit 106.

A user, an engineer or team of engineers as represented by reference numeral 114 generates the behavioral definitions via the interface 112, which may be a command line interface or a graphical user interface, for example. The behavioral definitions interface 112 permits the user 114 to select the timing/state logic analyzer modules, pattern generator modules, trace analysis modules, and data post-processing and protocol tools that satisfy the requirements of the planned exercise. In one embodiment, to effectuate these selections, the behavioral definitions interface 112 provides a representation of the embedded logic analyzer 105 and the target circuit 106 to the user 114 who selects the information from the target circuit 106 that should be made visible with respect to the embedded logic analyzer 105. Additionally, the user may select how the sampled information should be viewed and when recording or capture of the information should be started. In one embodiment, the embedded logic analyzer programmer 104 utilizes a trigger state control mechanism that may be effectuated by hardware or software to perform the recording and capture functionalities. Further, the user 114 may utilize the behavioral definitions interface 112 to select how the data is qualified and what types of data are stored.

By way of example, set forth below is a behavioral definition file embodiment that may be provided as an input file to the programmer module 104:

la_final_state = 3 # Trigger when we hit state 3
state 0:

if (0×0f1) occurs 0×1f3

next_state 1

elsif (0×0f2)

next_state 2

elsif (0×0f3)

next_state 3

else

next_state 0

end_state
state 1:

if (0×1f1) occurs 0×0f3

next state 1

elseif1 (0×1f2)

next_state 2

elseif2 (0×1f3)

next state 3

else

next_state 1

end_state
state 2:

if (0×1f1)

next state 0

elsif (0×1f2)

next_state 0

elsif (0×1f3)

next_state 3

else

next_state 2

end_state

Continuing to refer to FIG. 1, the embedded logic analyzer programmer 104 utilizes the behavioral definitions to generate the programmation file 116 that is operable to manipulate the ELA 105 of the target circuit 106 such that one or more selected observation operations may be performed on the target circuit 106. The observability tool module 108, which may be a compiled software module or an industry-standard tool, for example, is operable to provide compliance between the contents of the programmation file 116 and the ELA 105. A capture buffer file 118 is provided for capturing the observability results upon completion of testing the target circuit's functional behavior. As previously discussed, the user 114 can qualify the type of results to be stored in the capture buffer file 118 using the behavioral definitions interface 112. The capture buffer file 118 can be forwarded to the embedded logic analyzer programmer 104, which performs additional observation operations, testing, and analysis. In one embodiment, external instrumentation 120 may also be provided (to be external with respect to the host subsystem 102) which may include emulation probes and trace port analyzers that can support additional coordinated system analysis of hardware, software, and firmware interaction over a wide range of circuits including processors and ASICs. The results of further operations by the external instrumentation 120 are outputted in a results buffer file 122 which may also be forwarded to the embedded logic analyzer programmer 104. It should be appreciated that although the system 100 as illustrated may be utilized with external instrumentation 120, such external instrumentation is not necessary for purposes of the instant patent application. Regardless of application of the external instrumentation 120, the embedded logic analyzer programmer 104 is operable to display the results of the observed target circuit 106 to the user 114 by way of a results interface 124, i.e., a second interface, which is also external with respect to the target circuit 106.

By way of example, set forth below is a programmation file generated by the programmer module 104 responsive to the exemplary behavioral definition file embodiment set forth hereinabove:

# Begin programming the embedded logic analyzer
W : PERF : PERF_LA_BUFF_CTL : 0x000000000003fc17
W : PERF : PERF_LA_DLY : 0x0000000007ff68ef
# Write trigger state machine program
# Reset trigger state machine program
W : PERF : PERF_LA_CTL : 0x0002000000000000
# Write a state definition (state 0)
W : PERF : PERF_LA_TRIG_PROG : 0x0007cd8f343c88f1
# Enable the definition to be written and step
W : PERF : PERF_LA_CTL : 0x0001800000000000
# Write a state definition (state 1)
W : PERF : PERF_LA_TRIG_PROG : 0x0003cd9f347c89f1
# Enable the definition to be written and step
W : PERF : PERF_LA_CTL : 0x0001800000000000
# Write a state definition (state 2)
W : PERF : PERF_LA_TRIG_PROG : 0x0000019f307c81f1
# Enable the definition to be written and step
W : PERF : PERF_LA_CTL : 0x0001800000000000
# Program store qualify, final state, and reset state machine
W : PERF : PERF_LA_CTL : 0x001a000f4567adef
# Start all the counters
W : PERF : PERF_GLOB_START_STOP : 0x00000000000007ff

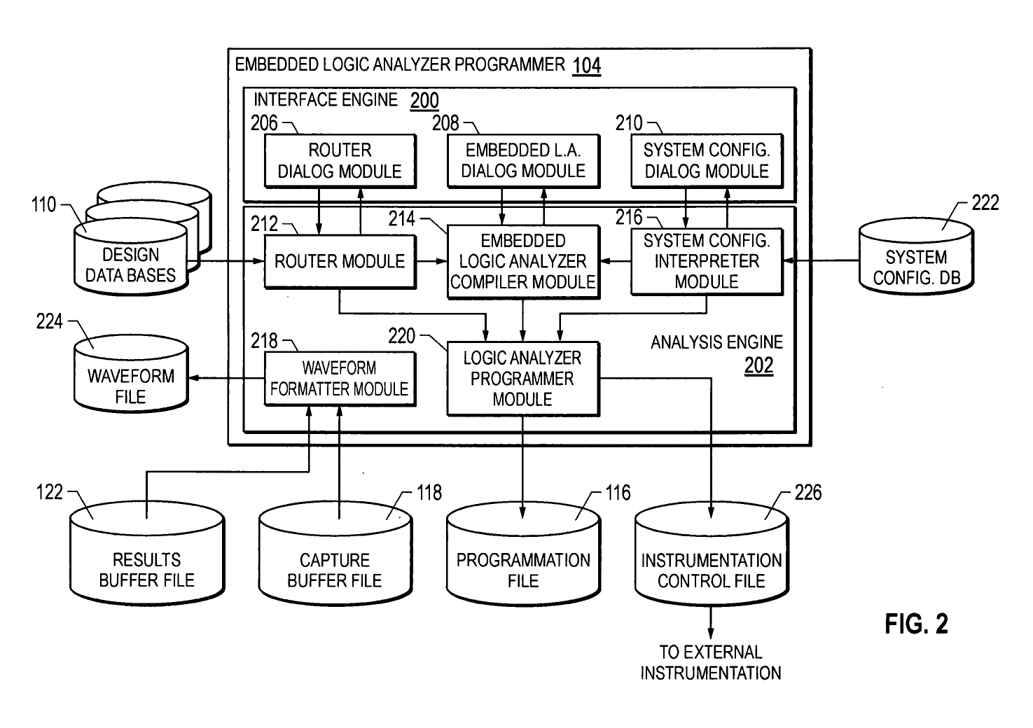

FIG. 2 depicts an embodiment of the embedded logic analyzer programmer 104 illustrated in FIG. 1. An interface engine 200 provides the behavioral definitions interface 112 (FIG. 1) and the results interface 124 (FIG. 1) that gather the information necessary to configure the embedded logic analyzer 105 to observe one or more selected aspects of the functionality of the target circuit 106 (FIG. 1). The observing of the target circuit 106 is handled by an analysis engine 202 which, additionally, provides the required interfaces to external instrumentation 120. It should be appreciated that the interface engine 200 and analysis engine 202 may each or together comprise any combination of hardware, software, or firmware. For example, in an ASIC embodiment, the interface engine 200 and analysis engine 202 comprise hardware portions of an ASIC having instructions programmed therein.

The interface engine 200 includes a router dialog module 206, embedded logic analyzer dialog module 208, and a system configuration dialog module 210. The router dialog module 206 manages the portion of the behavioral definitions interface 112 that permits the user 114 to select the signals that are used for observing the target circuit 106. The embedded logic analyzer dialog module 208 manages the portion of the behavioral definitions interface 112 that permits the user 114 to program the programmer's state, storage qualification, and triggering. The system configuration dialog module 210 manages the portion of the behavioral definitions interface 112 that permits users to load and define the target circuit's hardware configuration.

It should be appreciated that the router dialog module 206, embedded logic analyzer dialog module 208, and system configuration dialog module 210 may have functionalities with respect to the results interface 124 as well. In particular, each of the modules 206-210 performs reciprocal functions with respect to the results interface 124. For example, the router dialog module 206 is operable to manage the portion of the results interface 124 that permits the user 114 to review the signals that were used for observing the target circuit 106. Likewise, the embedded logic analyzer dialog module 208 is operable to manage the portion of the results interface 124 that permits the user 114 to review the results, e.g., the states before and after performing the observation operations with respect to the target circuit's functional behavior. The system configuration dialog module 210 may interact with the results interface 124 so that users can view the target circuit's hardware configuration.

The analysis engine 202 includes a router module 212, an embedded logic analyzer compiler 214, a system configuration interpreter module 216, a waveform formatter module 218, and a logic analyzer programmer module 220. The router module 212 interfaces with the router dialog module 206 to traverse the design databases 110 to determine the component configuration necessary in the internal circuitry and target circuit 106 to bring visibility to the exercised internal signals. For example, in the ASIC embodiment, the router dialog module 206 traverses the design databases 110 to determine the multiplexer (MUX) circuit configuration necessary to bring the ASIC internal signals onto the observability bus. The router module 212 also handles signal timing and latency equalization. In one implementation, different signals may be disposed at different distances from the embedded logic analyzer 104. In instances where distance is measured in clock cycles, the router module 212 delays the closer signals in order to synchronize them with the further signals. In one embodiment, the router module 212 accomplishes this latency equalization by programming additional clock delays into the faster signals. Additionally, in the embodiment that utilizes an observability bus, the router module 212 handles signal packing and management on the observability bus.

The embedded logic analyzer compiler 214 interfaces with the router module 212, embedded logic analyzer module 208, and system configuration interpreter module 216 to interpret the user's instructions to program the logic analyzer's state machine, storage qualification, and triggering between multiple embedded logic analyzers, where provided, that are associated with various target circuits 106 of the host subsystem 102. The system configuration interpreter module 216 interfaces with the system configuration dialog module 210 and a system configuration database 222 to determine the signal paths to control registers within the target circuit 106. The waveform formatter 218 receives data from the results buffer file 122 and capture buffer file 118 to produce a waveform file 224 that reconstitutes the results in a format compatible with a waveform viewing program. In one embodiment, the waveform file 224 maybe accessed by the interface engine 200 and displayed via the results interface 124.

The logic analyzer programmer module 220 interfaces with the router module 212, embedded logic analyzer compiler 214, and system configuration interpreter module 216 to generate one or more programmation files 116 which describe the required values that should be written to control registers, as well as an instrumentation control file 226 which provides instructions that can be imported into industry-standard or proprietary external instrumentation in order to further analyze and exercise the target circuit 106.

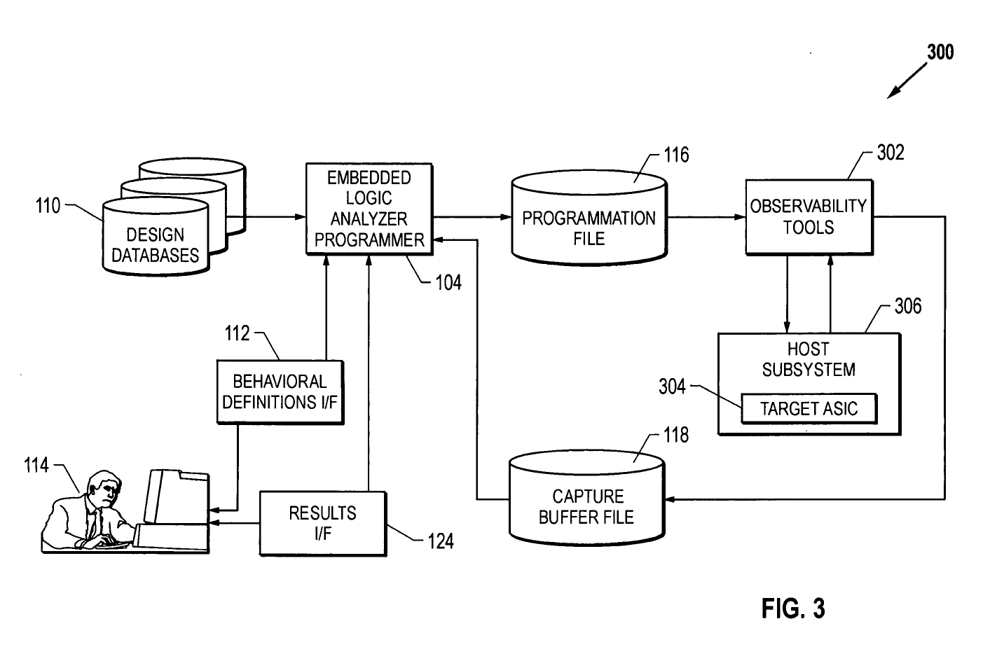

In general, FIGS. 3-6 define four embodiments of the system 100 depicted in FIG. 1 that utilize an embedded logic analyzer implementation in order to accelerate the verification process by gaining access and visibility into internal states of a target circuit. Those skilled in the art will appreciate that these design embodiments are conducive to obtaining economic efficiencies by reducing reliance on expensive external verification tools. More particularly, FIG. 3 depicts a first embodiment of a system 300 for observing the target circuit, which is depicted as a target ASIC 304 associated with a host subsystem 306. In operation, the embedded logic analyzer programmer 104 provides the behavioral definitions interface 112 to the user 114. Once the behavioral definitions are created using the inputs provided by the user 114 and the design databases 110, the embedded logic analyzer programmer 104 generates a programmation file 116 that is utilized by observability tools 302 for manipulating an embedded logic analyzer (not shown) of the target ASIC 304. As previously discussed, the programmation file 116 embodies the measurement modules, probing and analysis options selected by the user 114 to debug and validate the target ASIC circuit 304. In one embodiment, the observability tools 302 include an industry-standard tool that is compliant with the IEEE 1149.x protocol or Joint Test Action Group (JTAG) protocol. In this embodiment, the target ASIC 304 permits observability via an observability bus, e.g., debug bus, having connections with various test access ports (TAPs). The results of the exercises are transferred to the embedded logic analyzer programmer 104 which displays the results to the user 114 via the results interface 124. In one implementation, the results characterize the debug problems and validation with a series of “eye” diagrams and patterns which are navigable by the user 114. It should be appreciated that although an ASIC embodiment of the target circuit 304 is illustrated, the teachings presented in the instant application are applicable to other integrated circuits as well. For example, a logic device such as a field programmable gate array (FPGA) or general purpose processor circuit may be provided with an embedded logic analyzer operable with appropriate behavioral definitions interface and results interface may be utilized in the system 300.

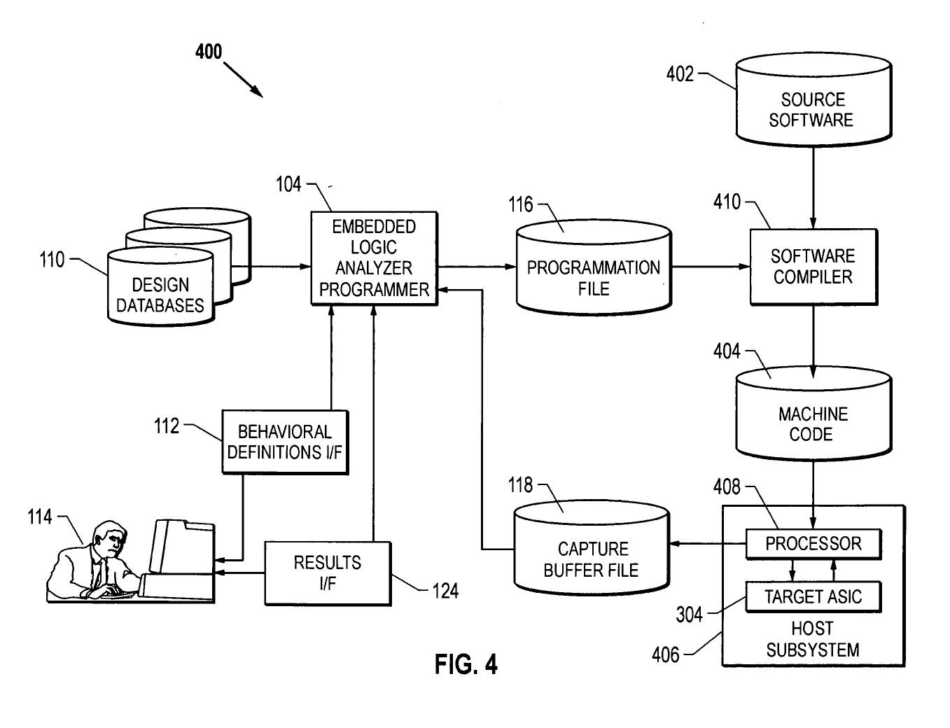

FIG. 4 depicts a second embodiment of a system 400 for observing the target circuit, which is depicted as ASIC 304 associated with a processor 408 that is part of a host subsystem 406. Again, the logic analyzer portion that is embedded within the target circuit is not particularly shown. As previously discussed, the embedded logic analyzer programmer 104 generates the programmation file 116 with the inputs provided by the design databases 110 and the user 114. For example, in one embodiment, the programmation file 116 may include instructions for executing a real-time trace analysis on the target ASIC circuit 304. Since processor 408 is utilized in observing the ASIC 304, a suitable source software module 402 and software compiler module 410 are also provided for interfacing with the programmation file 116. In one implementation, the software compiler 410 and source software 402 are operable with a general purpose programming language such as C, C++, or Java, for example. Utilizing the programmation file 116 and the source software 402, the software compiler 410 generates machine code 404 (including a logic analyzer enablement) which is driven to the processor 408 for effectuating the functionality of an observability tool. The processor 408, in turn, interfaces with the logic analyzer of the target ASIC 304 and outputs the results to the embedded logic analyzer programmer 104 by employing the capture buffer file 118. As discussed previously, the results, which contain access to individual, widely dispersed signals, may then be presented to user 114 by way of the results interface 124.

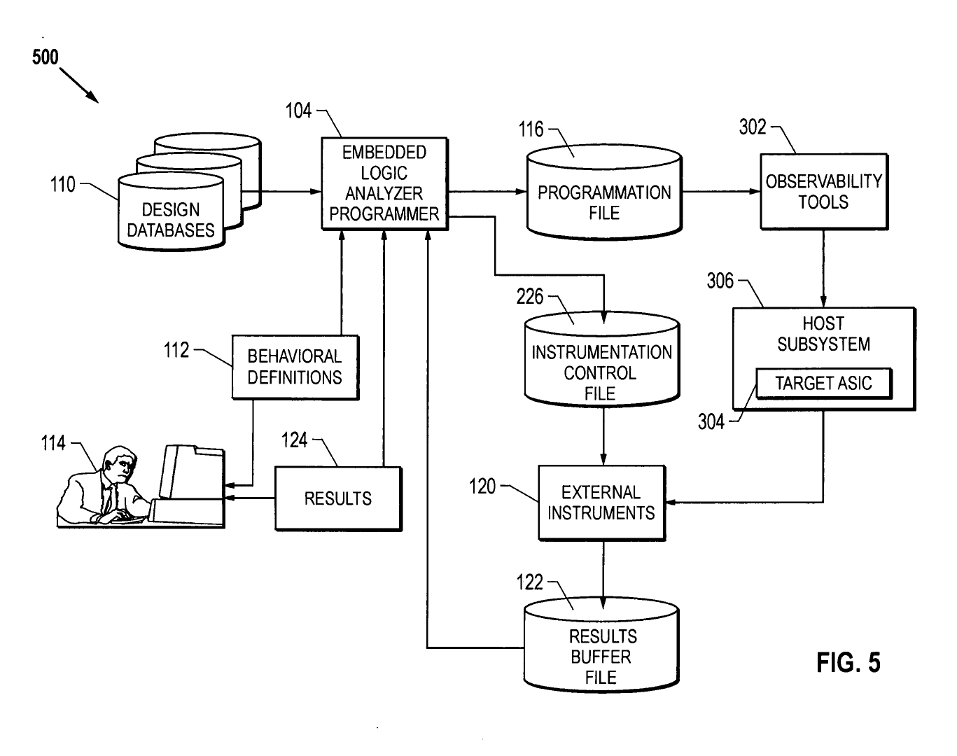

FIG. 5 depicts the third embodiment of a system 500 for observing the target ASIC circuit 304 in conjunction with external instrumentation. Similar to FIG. 3, the embedded logic analyzer programmer 104 generates a programmation file 116 and provides programmation file 116 to the observability tool 302. The embedded logic analyzer programmer 104 also generates an instrumentation control file 226 that controls the operation of the external instrumentation 120. As illustrated, the programmation file 115 (via observability tool 302) as well as the external instrumentation 120 are employed in effectuating observation operations with respect to the functionality of the target ASIC 304. The results of the observation operations are stored in a results buffer file 122 which is forwarded to the embedded logic analyzer programmer 104 for display to the user 114 with the results interface 124.

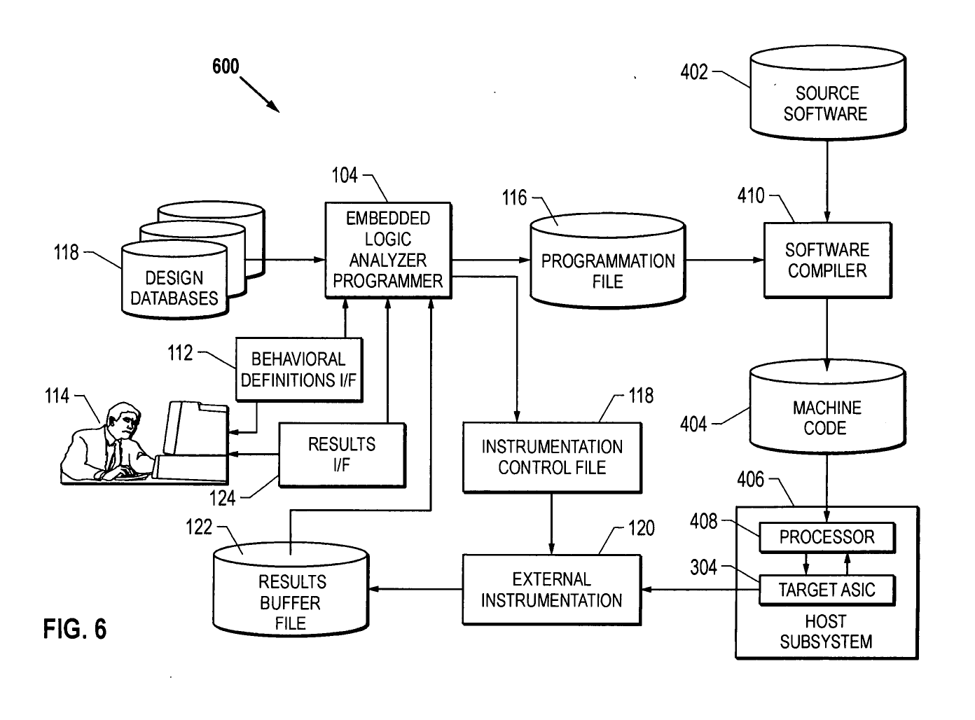

FIG. 6 depicts the fourth embodiment of a system 600 for observing the target ASIC circuit 304 utilizing external instrumentation as well as a general purpose programming language. Similar to FIG. 4, user 114 employs the behavioral definitions interface 112 supported by the embedded logic analyzer programmer 104 to create the programmation file 116, which, in turn, is provided to the software compiler 410. Responsive to the source software 402 and the programmation file 116, the software compiler 410 generates the machine code 404 that the processor 408 utilizes for manipulating the embedded logic analyzer (not shown) with respect to the target ASIC 304. The results of the selected observation operations are supplied to the external instrumentation 120, which performs further analysis under the direction of the instrumentation control file 118 produced by the embedded logic analyzer programmer 104. The results as constituted in the results buffer file 122 are forwarded to the embedded logic analyzer programmer 104 for display to the user 112 via the results interface 124.

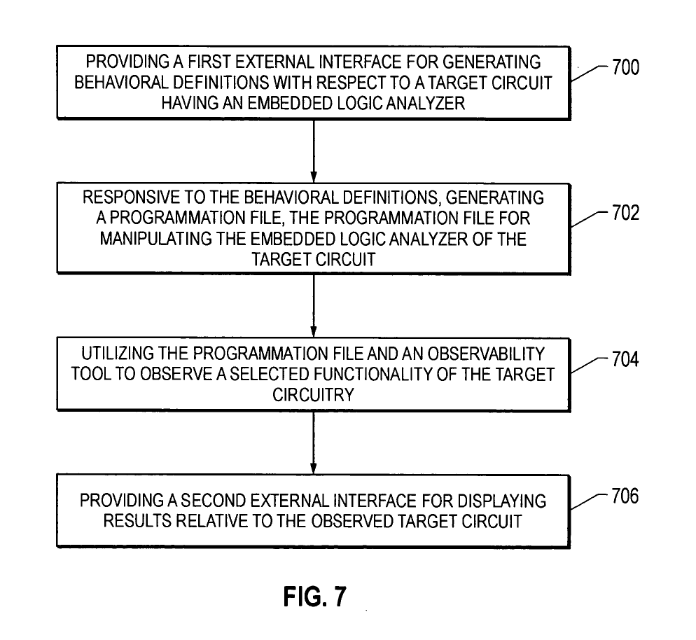

FIG. 7 depicts a flow chart of a computer-implemented methodology for observing a target circuit according to one embodiment. At block 700, a first external interface is provided for generating behavioral definitions with respect to a target circuit having an embedded logic analyzer. At block 702, responsive to the behavioral definitions, a programmation file is generated for manipulating the embedded logic analyzer so as to observe one or more selected components of the target circuit's functional behavior. At block 704, the programmation file is interfaced with an observability tool for observing a selected functionality of the target circuit. As previously discussed, the programmation file may be interfaced with a standard programming language environment or JTAG protocol-based observability tools. After the embedded logic analyzer has been triggered and system state information is stored in the capture buffer, an embedded logic analyzer programmer can be used to display the target circuit's internal states. At block 706, a second external interface is provided for displaying results relative to the observed target circuit. Accordingly, the computer-implemented methodology supporting a logic analyzer embedded within a circuit as described herein not only obviates the need for expensive external test equipment, but also provides for improved, non-intrusive access to internal signal states of the target circuit.

Although the invention has been particularly described with reference to certain illustrations, it is to be understood that the forms of the invention shown and described are to be treated as exemplary embodiments only. Various changes, substitutions and modifications can be realized without departing from the spirit and scope of the invention as defined by the appended claims.

What is claimed is:

1. A system for observing a target circuit's behavior, comprising:
a first interface for generating behavioral definitions, said first interface being external with respect to said target circuit;
a programmer module for generating a programmation file responsive to said behavioral definitions, said programmation file for manipulating a logic analyzer embedded with respect to said target circuit;
an observability tool for utilizing said programmation file to observe said target circuit's functionality; and
a second interface for displaying results relative to observing said target circuit's functionality, said second interface being external with respect to said target circuit.

2. The system as recited in claim 1, wherein said first interface comprises an interface selected from the group consisting of a command line interface and a graphical user interface.

3. The system as recited in claim 1, wherein said behavioral definitions are operable to define functionalities of said target circuit that are selected to be made visible with respect to said logic analyzer.

4. The system as recited in claim 1, wherein said observability tool is effectuated with a general purpose programming language.

5. The system as recited in claim 1, wherein said observability tool is effectuated with a Joint Test Action Group (JTAG) protocol.

6. The system as recited in claim 1, further comprising external instrumentation for observing said target circuit.

7. The system as recited in claim 1, wherein said second interface comprises an interface selected from the group consisting of a command line interface and a graphical user interface.

8. A computer-implemented methodology for observing a target circuit's behavior, comprising:
providing a first external interface for generating behavioral definitions with respect to said target circuit;
responsive to said behavioral definitions, generating a programmation file, said programmation file for manipulating a logic analyzer embedded with respect to said target circuit;
utilizing said programmation file and an observability tool to observe said target circuit's functionality; and
providing a second external interface for displaying results relative to observing said target circuit's functionality.

9. The computer-implemented methodology as recited in claim 8, wherein said operation of providing a first external interface further comprises providing an interface selected from the group consisting of a command line interface and a graphical user interface.

10. The computer-implemented methodology as recited in claim 8, wherein said operation of generating a programmation file further comprises defining functionalities of said target circuit that are selected to be visible with respect to said embedded logic analyzer.

11. The computer-implemented methodology as recited in claim 8, wherein said programmation file is interfaced with an observability tool that is effectuated with a general purpose programming language.

12. The computer-implemented methodology as recited in claim 8, wherein said programmation file is interfaced with an observability tool that is effectuated with a Joint Test Action Group (JTAG) protocol.

13. The computer-implemented methodology as recited in claim 8, further comprising utilizing instrumentation external with respect to said target circuit for observing said target circuit's functionality.

14. The computer-implemented methodology as recited in claim 8, wherein said operation of providing a second external interface further comprises providing an interface selected from the group consisting of a command line interface and a graphical user interface.

15. A system for observing a target circuit's behavior, comprising:
means for generating behavioral definitions with respect to said target circuit;
means, responsive to said behavioral definitions, for generating a programmation file, said programmation file for manipulating a logic analyzer embedded with respect to said target circuit;
means for utilizing said programmation file in order to observe said target circuit's functionality; and
means for displaying results relative to observing said target circuit's functionality.

16. The system as recited in claim 15, wherein said means for generating behavioral definitions comprises an external interface selected from the group consisting of a command line interface and a graphical user interface.

17. The system as recited in claim 15, wherein said means for generating a programmation file further comprises means for defining functionalities of said target circuit that are selected to be visible with respect to said logic analyzer.

18. The system as recited in claim 15, wherein said means for utilizing said programmation file comprises an observability tool that is effectuated with a general purpose programming language.

19. The system as recited in claim 15, wherein said means for utilizing said programmation file comprises an observability tool that is effectuated with a Joint Test Action Group (JTAG) protocol.

20. The system as recited in claim 15, further comprising means for utilizing instrumentation external with respect to said target circuit to observe said target circuit's selected functionality.

21. The system as recited in claim 15, wherein said means for displaying results comprises an external interface selected from the group consisting of a command line interface and a graphical user interface.

22. A computer platform, comprising:
a circuit;
a logic analyzer embedded within said circuit;
a first external interface for generating behavioral definitions relative to said circuit;
a programmer structure for creating a programmation file responsive to said behavioral definitions, said programmation file for manipulating said logic analyzer;
an observability tool for utilizing said programmation file to observe said circuit's selected functionality; and
a second external interface for displaying results obtained upon observing said circuit's selected functionality.

23. The computer platform as recited in claim 22, wherein said circuit comprises an Application Specific Integrated Circuit (ASIC).

24. The computer platform as recited in claim 22, wherein said first and second interfaces comprise graphical user interfaces.

25. The computer platform as recited in claim 22, wherein said first and second interfaces comprise command line interfaces.

26. The computer platform as recited in claim 22, wherein said programmer structure is operable to interface with external instrumentation to observe said circuit's selected functionality.
